(19) United States
(12) Patent Application Publication
(10) Pub. No.: US 2021/0167652 A1
(43) Pub. Date: Jun. 3, 2021

(54) METHOD FOR ADJUSTING HIGH EFFICIENCY REGION OF PERMANENT MAGNET MOTOR

(71) Applicant: JIANGSU UNIVERSITY, Jiangsu (CN)

(72) Inventors: Qian CHEN, Jiangsu (CN); Xun FAN, Jiangsu (CN); Guohai LIU, Jiangsu (CN); Wenxiang ZHAO, Jiangsu (CN); Jinghua JI, Jiangsu (CN); Gaohong XU, Jiangsu (CN)

(21) Appl. No.: 15/778,938

(22) PCT Filed: Jun. 30, 2017
(86) PCT No.: PCT/CN2017/091038

§ 371 Date: May 24, 2018

(30) Foreign Application Priority Data
May 24, 2017 (CN) 201710371640.7

(51) Int. Cl. H02K 3/28; H02K 29/03

(52) U.S. Cl. CPC H02K 3/28; H02K 2213/03; H02K 29/03

(57) ABSTRACT

This invention proposes a method to regulate high efficiency region of permanent magnet motor. The internal relationship between the point with maximum efficiency and the points around it is firstly revealed. Then, the optimal combination of copper loss, iron loss and permanent magnet eddy-current loss is presented when maximum efficiency point moves toward different directions. Hence, the method for regulating high efficiency region can be obtained. This method can be suitable for any type of permanent magnet motors, which can adjust high efficiency region to the dense working point area of the motor under different operating conditions according to design requirements. If this method is used into electric vehicle, it can combine the high efficiency region with the electric vehicle driving cycle to reduce energy consumption and enhance the life mileage of electric vehicle effectively.

### BACKGROUND OF THE INVENTION

### 1. Field of the Invention

The invention relates to design of permanent magnet motor, in particular for regulating high efficiency region of permanent magnet motor, which belongs to field of motor manufacturing.

### 2. Description of Related Art

Nowadays, permanent magnet motor plays a very important role and has been widely used into variable applications, such as electric vehicle and ship propulsion. This is mainly due to several significant advantages of permanent magnet motors, including high torque density, high power density and small weight and volume. Meanwhile, peinianent magnet motor adopts magnetic material with high magnetic energy, instead of traditional excitation winding. It not only avoids the negative effects resulted from traditional excitation winding, but also simplifies the mechanical structure of motor, which improves the reliability of motor and reduces the mechanical loss.

Although the permanent magnet motor has a series of advantages, there are still some shortcomings in the application of electric vehicle drive system. Especially, the inconsistency between the driving cycles of the electric vehicle and high efficiency region of the permanent magnet motor, which causes the waste of energy and the decrease of efficiency. If the high efficiency region of permanent magnet motor should be adjusted to the area corresponding to the given driving cycle of the electric vehicle, the electric vehicle will operate in the high efficiency region, thus saving energy. Therefore, it is very valuable to study the method for adjusting the high efficiency region of permanent magnet motor.

At present, the regulation of high efficiency region has been studied deeply, such as optimizing the shape of permanent magnet, optimizing the ratio of axial length and winding turns, etc. One of common disadvantages of these methods is that they all expand the high efficiency region of the motor by reducing the loss, and then the high efficiency region is just improve, while the position of the high efficiency region is fixed. Therefore, it is necessary to study how to reveal the regulation method to move high efficiency region towards target area.

### SUMMARY OF THE INVENTION

The aim of this invention is to propose a method to regulate high efficiency region. Base on accurate analysis of high efficiency region regulation method, the optimal loss combination among copper loss, iron loss and permanent magnet eddy-current loss will be obtained. Then, the high efficiency region will be regulated to the corresponding area of electric vehicle under given driving cycles, thus improving efficiency and saving energy.

Technical scheme of the invention is how to regulate high efficiency region of permanent magnet motor, including the following steps:

Step 1: Constant torque region of the target motor is firstly analyzed. In the constant torque region, point ‘1’ is set as the point with maximum efficiency, and points ‘2’, ‘3’, ‘4’ and ‘5’ are selected as four directions around point ‘1’. Then the relationship between the maximum efficiency point and other points is constructed.

Step 2: The relationships of speed and current between the maximum efficiency point ‘1’ and the top point ‘2’ in the constant torque region are n₂=n₁ and I₂=k₂I₁. Then, the copper loss relationship between two points is obtained as p_{copp2}=k₂²P_{copp1}. Furthermore, if the efficiency of point ‘1’ is greater than that of point ‘2’, the equation k₂P_{copp1}≥Pᵢᵣₒₙ₁+P_{PM1} will be deduced.

Step 3: The relationships of speed and current between the maximum efficiency point ‘1’ and the bottom point ‘3’ in the constant torque region are n₃=n₁ and I₃=k₃I₁. Then, the copper loss relationship between two points is obtained as P_{copp3}=k₃²P_{copp1}. Furthermore, if the efficiency of point ‘1’ is greater than that of point ‘3’, the equation k₃P_{copp1}<Pᵢᵣₒₙ₁+P_{PM1} will be deduced.

Step 4: The relationships of current, torque and speed between the maximum efficiency point ‘1’ and the right point ‘4’ in the constant torque region are I₄=I₁, T₄=T₁ and n₄=k₄n₁. Then, the relationships of copper loss, hysteresis iron loss, eddy-current iron loss, additional iron loss and permanent magnet eddy-current loss are obtained as P_{copp4}=P_{copp1}, Pₕ₄=k₄Pₕ₁, P_{c4}k₄²P_{c1}, P_{E4}=k₄^{1.5}P_{E1}, and P_{PM4}=k₄²P_{PM1}. Furthermore, if the efficiency of point ‘1’ is greater than that of point ‘4’, the equation P_{copp1}<k₄(P_{c1}+P_{E1}+P_{PM1}) will be deduced.

Step 5: The relationships of current, torque and speed between the maximum efficiency point ‘1’ and the left point ‘5’ in the constant torque region are I₅=I₁, T₅=T₁ and n₅=k₅n₁. Then, the relationships of copper loss, hysteresis iron loss, eddy-current iron loss, additional iron loss and permanent magnet eddy-current loss are obtained as P_{copp5}=P_{copp1}, Pₕ₅=k₅Pₕ₁, P_{c4}=k₄²P_{c1}, P_{E5}=k₅^{1.5}P_{E1} and P_{PM5}=k₅²p_{PM1}. Furthermore, if the efficiency of point ‘1’ is greater than that of point ‘5’, the equation p_{copp1}≥k₅(P_{c1}+P_{E1}+P_{PM1}) will be deduced.

Step 6: From Step 2 to Step 5, the maximum efficiency point needs to satisfy some equations, and then, the high efficiency point can be moved in horizontal and vertical direction according these equations.

Step 7: Since the equations from Step 2 to Step 5 is only deduced in constant torque region, the effectiveness of these equations should be verified in others region like the connective region between constant torque region and constant power region.

Step 8: The combination of copper loss, iron loss and permanent magnet eddy-current loss are analyzed to make point ‘1’ as the maximum efficiency point. Then, three methods for adjusting the ratio of loss in high efficiency region by changing the parameters of winding, permanent magnet and silicon steel sheet are put forward.

Step 9: The correctness of the proposed methods for adjusting high efficiency region is verified by a specific driving cycles.

Further, the detail process of Step 2 is realized as follow:

Firstly, the relationship of speed and current between point ‘1’ and point ‘2’ is established as:

$$\{ \begin{matrix}{n}_{2} = {n}_{1} \\ {I}_{2} = {k}_{2} {I}_{1}\end{matrix}$$

where n₂ is the speed of point ‘2’, n₁ is the speed of point ‘1’, I₂ is the winding current amplitude of point ‘2’, I₁ is the winding current amplitude of point ‘1’, and k₂ is a coefficient which is greater than 1.

Secondly, the corresponding torque, electromagnetic power and copper loss are obtained from the relationship of speed and current between point ‘1’ and point ‘2’:

$$\{ \begin{matrix}{T}_{2} = {k}_{2} {T}_{1} \\ {P}_{e 2} = {k}_{2} {P}_{e 1} \\ {P}_{c o p p 2} = {k}_{2}^{2} {P}_{copp 1}\end{matrix}$$

where T₂ is the torque of point ‘2’, T₁ is the torque of point ‘1’, Pₑ₂ is the power of point ‘2’, Pₑ₁ is the power of point ‘1’, P_{copp2} is the copper loss of point ‘2’, and P_{copp1} is the copper loss of point ‘1’.

Thirdly, ignoring motor mechanical loss and wind friction loss, the efficiency expressions of point ‘1’ and point ‘2’ are written out as follows:

$$\{ \begin{matrix}{η}_{1} = \frac{{P}_{e 1}}{{P}_{e 1} + {P}_{copp 1} + {P}_{iron 1} + {P}_{PM 1}} \\ {η}_{2} = \frac{{P}_{e2}}{{P}_{e 2} + {P}_{copp 2} + {P}_{iron 2} + {P}_{PM 2}}\end{matrix}$$

where η₂ is the efficiency of point ‘2’, η₁ is the efficiency of point ‘1’, P₁ᵣₒₙ₂ is the iron loss of point ‘2’, Pᵢᵣₒₙ₁ is the iron of point ‘1’, P_{PM2} is the permanent magnet eddy-current loss of point ‘2’, and P_{PM1} is the permanent magnet eddy-current loss of point ‘1’.

Finally, if the efficiency of point ‘1’ is greater than that of point ‘2’, the following equation will be obtained:

$$\{ \begin{matrix}y = {k}_{2} ( {k}_{2} - 1 ) {P}_{copp 1} > ( {k}_{2} {P}_{iron 1} - {P}_{iron 2} ) + ( {k}_{2} {P}_{PM 1} - {P}_{PM 2} ) = x \\ z = ( {k}_{2} - 1 ) {P}_{iron 1} + ( {k}_{2} - 1 ) {P}_{PM 1} > x\end{matrix}$$

When point ‘1’ and point ‘2’ are very close to each other, Pᵢᵣₒₙ₂ and P_{PM2} are slightly greater than Pᵢᵣₒₙ₁ and P_{PM1}, respectively. Thus, z is slightly greater than x, while x is smaller than y. After simplification, the following equation can be obtained:

k₂P_{copp1}≥Pᵢᵣₒₙ₁+P_{PM1}

Further, the detail process of Step 3 is realized as follow:

Firstly, the relationship of speed and current between point ‘1’ and point ‘3’ is established as follow:

$$\{ \begin{matrix}{n}_{3} = {n}_{1} \\ {I}_{3} = {k}_{3} {I}_{1}\end{matrix}$$

where n₃ is the speed of point ‘3’, I₃ is the winding current amplitude of point ‘3’, and k₃ is a coefficient which is smaller than 1.

Secondly, the corresponding torque, electromagnetic power and copper loss are obtained from the relationship of speed and current between point ‘1’ and point ‘3’:

$$\{ \begin{matrix}{T}_{3} = {k}_{3} {T}_{1} \\ {P}_{e3} = {k}_{3} {P}_{e 1} \\ {P}_{copp 3} = {k}_{3}^{2} {P}_{copp 1}\end{matrix}$$

Where T₃ is the torque of point ‘3’, Pₑ₃ is the power of point ‘3’, and P_{copp3} is the copper loss of point ‘3’.

Thirdly, ignoring motor mechanical loss and wind friction loss, the efficiency expressions of point ‘1’ and point ‘2’ are written out as follows:

$$\{ \begin{matrix}{η}_{1} = \frac{{P}_{e 1}}{{P}_{e 1} + {P}_{copp 1} + {P}_{iron ]} + {P}_{PM 1}} \\ {η}_{3} = \frac{{P}_{e 3}}{{P}_{e 3} + {P}_{copp 3} + {P}_{iron 3} + {P}_{PM 3}}\end{matrix}$$

where η₃ is the efficiency of point ‘3’, Pᵢᵣₒₙ₃ is the iron loss of point ‘3’, and P_{PM3} is the permanent magnet eddy-current loss of point ‘3’.

Finally, if the efficiency of point ‘1’ is greater than that of point ‘3’, the following equation will be obtained:

$$\{ \begin{matrix}y = {k}_{3} ( {k}_{3} - 1 ) {P}_{copp 1} > ( {k}_{3} {P}_{iron 1} - {P}_{iron 3} ) + ( {k}_{3} {P}_{PM 1} - {P}_{PM 3} ) = x \\ z = ( {k}_{3} - 1 ) {P}_{iron 1} + ( {k}_{3} - 1 ) {P}_{PM 1} < x\end{matrix}$$

When point ‘1’ and point ‘3’ are very close to each other, Pᵢᵣₒₙ₃ and P_{PM3} are slightly smaller than Pᵢᵣₒₙ₁ and P_{PM1}, respectively. Thus, z is slightly smaller than x, while x is smaller than y. After simplification, the following equation can be obtained:

k₃P_{copp1}<Pᵢᵣₒₙ₁+P_{PM1}

Further, the detail process of Step 4 is realized as follow:

Firstly, the relationship of current, torque and speed between point ‘1’ and point ‘4’ is established as follow:

$$\{ \begin{matrix}{I}_{4} = {I}_{1} \\ {T}_{4} = {T}_{1} \\ {n}_{4} = {k}_{4} {n}_{1}\end{matrix}$$

in where I₄ is the winding current amplitude of point ‘4’, T₄ is the torque of point ‘4’, n₄ is the speed of point ‘4’, and k₄ is a coefficient which is greater than 1.

Secondly, the corresponding electromagnetic power, copper loss, hysteresis iron loss, eddy-current iron loss, additional iron loss and permanent magnet eddy-current loss are obtained from the relationship of current, torque and speed between point ‘1’ and point ‘4’:

$$\{ \begin{matrix}{P}_{e 4} = {k}_{4} {P}_{e 1} \\ {P}_{copp 4} = {P}_{copp 1} \\ {P}_{h 4} = {k}_{4} {P}_{h 1} \\ {P}_{c 4} = {k}_{4}^{2} {P}_{c 1} \\ {P}_{E 4} = {k}_{4}^{1.5} {P}_{E 1} \\ {P}_{PM 4} = {k}_{4}^{2} {P}_{P M 1}\end{matrix}$$

where Pₑ₄ is the power of point ‘4’, P_{copp4} is the copper loss of point ‘4’, Pₕ₄ is the hysteresis iron loss of point ‘4’, Pₑ₄ is the eddy-current iron loss of point ‘4’, P_{E4} is the additional iron loss of point ‘4’, P_{PM4} is the permanent magnet eddy-current loss of point ‘4’, Pₕ₁ is the hysteresis iron loss of point ‘1’, P_{c1} is the eddy-current iron loss of point ‘1’, and P_{E1} is the additional iron loss of point ‘1’.

Thirdly, ignoring motor mechanical loss and wind friction loss, the efficiency expressions of point ‘1’ and point ‘4’ are written out as follows:

$$\{ \begin{matrix}{η}_{1} = \frac{{P}_{e 1}}{{P}_{e 1} + {P}_{copp 1} + {P}_{iron 1} + {P}_{PM 1}} \\ {η}_{4} = \frac{{P}_{e 4}}{{P}_{e 4} + {P}_{copp 4} + {P}_{iron 4} + {P}_{PM 4}}\end{matrix}$$

where η₄ is the efficiency of point ‘4’.

Finally, if the efficiency of point ‘1’ is greater than that of point ‘4’, the following equation will be obtained:

$$\{ \begin{matrix}v = ( {k}_{4} - 1 ) {P}_{copp 1} < ( {k}_{4}^{2} - {k}_{4} ) {P}_{c 1} + ( {k}_{4}^{1.5} - {k}_{4} ) {P}_{E 1} + ( {k}_{4}^{2} - {k}_{4} ) {P}_{P M 1} = u \\ w = ( {k}_{4}^{2} - {k}_{4} ) {P}_{c 1} + ( {k}_{4}^{2} - {k}_{4} ) {P}_{E 1} + ( {k}_{4}^{2} - {k}_{4} ) {P}_{M 1} > u\end{matrix}$$

When point ‘1’ and point ‘4’ are very close to each other, (k₄²−k₄) is slightly greater than (k₄^{1.5}−k₄). Thus, w is slightly greater than u, while u is greater than v. After simplification, the following equation can be obtained:

P_{copp1}<k₄(P_{c1}+P_{E1}+P_{PM1})

Further, the detail process of Step 5 is realized as follow:

Firstly, the relationship of current, torque and speed between point ‘1’ and point ‘5’ is established as follows:

$$\{ \begin{matrix}{I}_{5} = {I}_{1} \\ {T}_{5} = {T}_{1} \\ {n}_{5} = {k}_{5} {n}_{1}\end{matrix}$$

where I₅ is the winding current amplitude of point ‘5’, T₅ is the torque of point ‘5’, n₅ is the speed of point ‘5’, and k₅ is a coefficient which is smaller than 1.

Secondly, the corresponding electromagnetic power, copper loss, hysteresis iron loss, eddy-current iron loss, additional iron loss and permanent magnet eddy-current loss are obtained from the relationship of current, torque and speed between point ‘1’ and point ‘5’:

$$\{ \begin{matrix}{P}_{e 5} = {k}_{5} {P}_{e 1} \\ {P}_{copp 5} = {P}_{copp 1} \\ {P}_{h5} = {k}_{5} {P}_{h 1} \\ {P}_{c5} = {k}_{5}^{2} {P}_{c 1} \\ {P}_{E5} = {k}_{5}^{1.5} {P}_{E 1} \\ {P}_{PM 5} = {k}_{5}^{2} {P}_{P M 1}\end{matrix}$$

where Pₑ₅ is the power of point ‘5’, P_{copp5} is the copper loss of point ‘5’, Pₕ₅ is the hysteresis iron loss of point ‘5’, P_{c5} is the eddy-current iron loss of point ‘5’, P_{E5} is the additional iron loss of point ‘5’, and P_{PM5} is the permanent magnet eddy-current loss of point ‘5’.

Thirdly, ignoring motor mechanical loss and wind friction loss, the efficiency expressions of point ‘1’ and point ‘5’ are written out as follows:

$$\{ \begin{matrix}{η}_{1} = \frac{{P}_{e 1}}{{P}_{e 1} + {P}_{copp 1} + {P}_{iron 1} + {P}_{PM 1}} \\ {η}_{5} = \frac{{P}_{e 5}}{{P}_{e 5} + {P}_{copp 5} + {P}_{iron 5} + {P}_{PM 5}}\end{matrix}$$

Where η₅ is the efficiency of point ‘5’.

Finally, if the efficiency of point ‘1’ is greater than that of point ‘5’, the following equation will be obtained:

$$\{ \begin{matrix}v = ( {k}_{5} - 1 ) {P}_{copp 1} < ( {k}_{5}^{2} - {k}_{5} ) {P}_{c 1} + ( {k}_{5}^{1.5} - {k}_{5} ) {P}_{E 1} + ( {k}_{5}^{2} - {k}_{5} ) {P}_{P M 1} = u \\ w = ( {k}_{5}^{2} - {k}_{5} ) {P}_{c 1} + ( {k}_{5}^{2} - {k}_{5} ) {P}_{E 1} + ( {k}_{5}^{2} - {k}_{5} ) {P}_{M 1} < u\end{matrix}$$

When point ‘1’ and point ‘5’ are very close to each other, (k₅²−k₅)P_{E1} is slightly smaller than (k₅^{1.5}−k₅)P_{E1}. Thus, w is slightly smaller than u, while u is greater than v. After simplification, the following relationship can be obtained:

P_{copp1}≥k₅(P_{c1}+P_{E1}+P_{PM1})

Further, in Step 6, the high efficiency point can be moved in horizontal and vertical direction, when the loss in the motor satisfies following equation:

$$\{ \begin{matrix}{P}_{Vertical} = {P}_{copp} - ( {P}_{iron} + {P}_{P M} ) \approx 0 \\ {P}_{Horizontal} = {P}_{copp} - ( {P}_{c} + {P}_{E} + {P}_{PM} ) \approx 0\end{matrix}$$

Where P_{copp} represents copper loss, Pᵢᵣₒₙ represents iron loss, P_{PM} represents permanent magnet eddy-current loss, P_{c} represents eddy-current iron loss, and P_{E} represents additional iron loss. When P_{vertical} is greater than 0, the efficiency of the point is greater than that of top point; When P_{vertical} is smaller than 0, the efficiency of the point is greater than that of bottom point; When P_{Horizontal} is greater than 0, the efficiency of the point is greater than that of left point; When P_{Horizontal} is smaller than 0, the efficiency of the point is greater than that of right point. If high efficiency region is desired to be adjusted to the target area, P_{vertical} and P_{Horizontal} of the points of the target area should be optimized to approach 0.

Further, since the current will be smaller and the speed will be lower under the junction region of the constant torque region and the constant power region in Step 7, the current angle does not change and this region still meets the equation of high efficiency regulation in the constant torque region.

Further, in Step 8, the copper loss, iron loss and permanent magnet eddy-current loss can be represented by expressions as:

$$\{ \begin{matrix}{P}_{copp} = \frac{m {I}^{2} R}{2} \\ {P}_{iron} = {P}_{h} + {P}_{c} + {P}_{E} \\ {P}_{PM} = \frac{{K}^{2} {f}^{2} {L}_{a} {B}_{m}^{2} {L}_{m}^{2} V}{12 ρ ( {L}_{a} + {L}_{m} )}\end{matrix}$$

where m represents phase number of the motor, I represents winding current amplitude, represents winding resistance per phase, Pₕ represents hysteresis iron loss, K represents a electromotive force constant, f represents frequency, Lₐ represents axial length of the motor, Bₘ represents maximum flux density, Lₘ represents width of the permanent magnet, V represents volume, and ρ represents resistivity. Copper loss can be adjusted by changing the winding current amplitude or winding resistance, and winding resistance is mainly determined by the winding length after the determination of the line diameter. Iron loss can be adjusted by changing the magnitude of the armature magnetic field or the permanent magnetic field. Permanent magnet eddy current loss can be adjusted by rotor opening, radial or axial segmentation, changing the pole-arc coefficient of permanent magnet, changing the opening size of stator slot, and changing the permanent magnet material.

Further, in Step 8, the methods of adjusting the loss ratio of high efficiency region by changing the parameters of winding, permanent magnet and silicon steel sheet are put forward. To make high efficiency region move towards the top or left, the following measures can be adopted: reducing the current amplitude and increasing the number of winding turns, increasing the pole-arc coefficient of the permanent magnet, and increasing the opening size of the stator slot; Relatively, to make high efficiency region move towards the bottom or right, the following measures can be adopted: increasing the current amplitude and reducing the number of winding turns, reducing the pole-arc coefficient of the permanent magnet, reducing the opening size of the stator slot, and radial or axial segmentation of permanent magnet.

Finally, the proposed efficiency regulation method is suitable for any type of permanent magnet motor.

The beneficial effect of the invention:
a) In the invention, the area under the junction region of the constant torque region and the constant power region in efficiency map is deeply analyzed and the conditional relation of the efficiency between points and points in this region is revealed. Thus, the distribution of efficiency in the efficiency map is easier to be understood.
b) In the invention, the method to regulate high efficiency region reveals the equations that high efficiency region needs to satisfy. It provides theoretical guidance for adjusting high efficiency region to target area, and thus saving a lot of design time.
c) In the invention, the method to regulate high efficiency region is suitable for any type of permanent magnet motor. Firstly, it is suitable for radial, axial and transverse flux permanent magnet motors from the angle of the direction of the magnetic field. Also, it is suitable for integer slot distributed winding and fractional slot concentrated winding permanent magnet motor from the view of winding structures. Moreover, it is suitable for surface-mounted, embed and inset permanent magnet motors from the angle of permanent magnet installation.
d) In the invention, the method to regulate high efficiency region is suitable for a lot of driving cycles such as UDDS, NEDC and so on.
e) In the invention, the method can combine the high efficiency region with electric vehicle driving cycles. Thus, it can enhance the motor efficiency, reduce the energy consumption and increase the range of electric vehicles.

### BRIEF DESCRIPTION OF APPENDED DRAWINGS

The invention can be better understood on reading the following detailed description of non-restrictive illustrative embodiments of the invention and on examining the appended drawing, wherein:

FIG. 1 illustrates the relationship diagram between point ‘1’ and points ‘2’, ‘3’, ‘4’, ‘5’ in the constant torque region of the permanent magnet motor.

FIG. 2 illustrates the relationship diagram between point ‘1’ and point ‘2’ in the constant torque region of the permanent magnet motor.

FIG. 3 illustrates the relationship diagram between point ‘1’ and point ‘3’ in the constant torque region of the permanent magnet motor.

FIG. 4 illustrates the relationship diagram between point ‘1’ and point ‘4’ in the constant torque region of the permanent magnet motor.

FIG. 5 illustrates the relationship diagram between point ‘1’ and point ‘5’ in the constant torque region of the permanent magnet motor.

FIG. 6 shows UDDS driving cycle.

FIG. 7 shows corresponding torque and speed distribution diagram based on UDDS driving cycle and motor parameter.

FIG. 8 shows an embodied permanent magnet motor with three phases.

FIG. 9 shows motor efficiency map of the permanent magnet motor when pole-arc coefficient equals to 1.

FIG. 10 shows motor efficiency map data of the permanent magnet motor when pole-arc coefficient equals to 1.

FIG. 11 shows motor efficiency map of the permanent magnet motor when pole-arc coefficient equals to 0.3.

FIG. 12 shows motor efficiency map data of the peinianent magnet motor when pole-arc coefficient equals to 0.3.

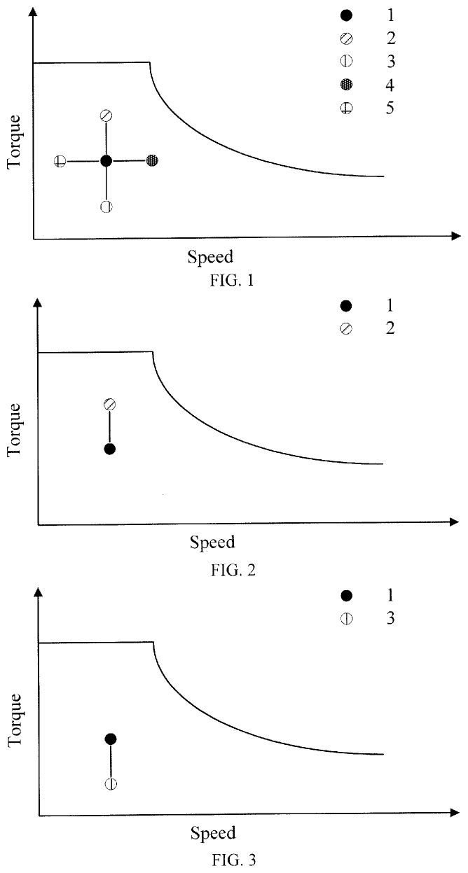

### DETAILED DESCRIPTION OF THE PREFERRED EMBODIMENTS

With reference to the appended drawings in the embodiment of the invention, the detailed embodiment of the invention is clearly and completely described as following.

The following embodiments are exemplary, only to explain the invention, but not as a limitation to the invention.

FIG. 2 illustrates the relationship diagram between point ‘1’ and point ‘2’ in the constant torque region of the permanent magnet motor. According to the position relation of two points in constant torque region, the relation between two points is listed as: n₂=n₁, I₂=k₂I₁; According to the relationship of speed and current, the torque, electromagnetic power and copper loss of two points are calculated as T₂=k₂T₁, Pₑ₂=k₂Pₑ₁, P_{copp2}=k₂²P_{copp1}. If the efficiency of point ‘1’ is greater than that of point ‘2’, equation k₂P_{copp1}≥pᵢᵣₒₙ₁+P_{PM1} will be deduced.

FIG. 3 illustrates the relationship diagram between point ‘1’ and point ‘3’ in the constant torque region of the permanent magnet motor. According to the position relation of two points in constant torque region, the relationship between two points is listed as n₃=n₁, I₃=k₃I₁; According to the relationship of speed and current, the torque, electromagnetic power and copper loss are calculated as T₃=k₃T₁, Pₑ₃=k₃Pₑ₃, P_{copp3}=k₃²P_{copp1}, If the efficiency of point ‘1’ is greater than that of point ‘3’, equation k₃P_{copp1}≥Pᵢᵣₒₙ₁+P_{PM1} will be deduced.

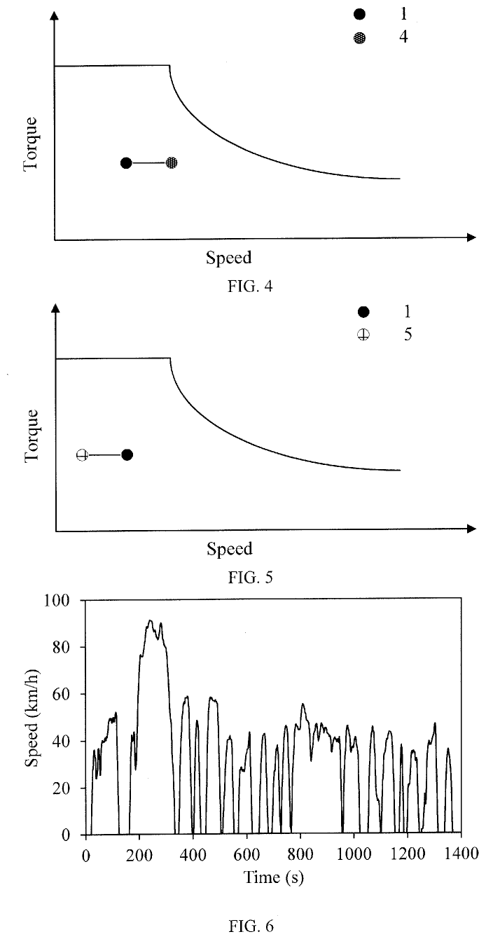

FIG. 4 illustrates the relationship diagram between point ‘1’ and point ‘4’ in the constant torque region of the permanent magnet motor. According to the position relationship of two points in constant torque region, the relationship between two points is listed as I₄=I₁, T₄=T₁, n₄=k₄n₁; According to the relationship of current, torque and speed, the electromagnetic power, copper loss, hysteresis iron loss, eddy-current iron loss and additional iron loss are calculated as Pₑ₄=k₄Pₑ₁, P_{copp4}=P_{copp1}, Pₕ₄=k₄Pₕ₁, P_{c4}=k₄²P_{c1}, P_{E4}=k₄^{1.5}=k₄^{1.5}P_{E1}. If the efficiency of point ‘1’ is greater than that of point ‘4’, equation P_{copp1}<k₄(P_{c1}+P_{E1}+P_{PM1}) will be deduced.

FIG. 5 illustrates the relationship diagram between point ‘1’ and point ‘5’ in the constant torque region of the permanent magnet motor. According to the position relationship of two points in constant torque region, the relationship between two points is listed as I₅=I₁, T₅=T₁, n₅=k₅n₁; According to the relationship of current, torque and speed, the electromagnetic power, copper loss, hysteresis iron loss, eddy-current iron loss and additional iron loss are calculated: Pₑ₅=k₅Pₑ₁, P_{copp5}=P_{copp1}, Pₕ₅=k₅Pₕ₁, P_{c5}=k₅²P_{c1}, P_{E5}=k₅^{1.5}P_{E1}. If the efficiency of point ‘1’ is greater than that of point ‘4’, equation P_{copp1}≥k₅(P_{c1}+P_{E1}+P_{PM1}) will be deduced.

According to the relationship between point ‘1’ and points ‘2’, ‘3’, ‘4’, ‘5’ in four directions, the equations that high efficiency region satisfies are summarized: P_{Vertical}=P_{copp}−(Pᵢᵣₒₙ+P_{PM})≈0, P_{Honzontal}=P_{copp}−(P_{c}+P_{E}+P_{PM})≈0·P_{copp} represents copper loss, Pᵢᵣₒₙ represents iron loss, P_{PM} represents permanent magnet eddy-current loss, P_{c} represents eddy-current iron loss, and P_{E} represents additional iron loss. When P_{vertical} is greater than 0, the efficiency of the point is greater than that of top point; When P_{vertical} is smaller than 0, the efficiency of the point is greater than that of bottom point; When P_{Horizontal} is greater than 0, the efficiency of the point is greater than that of left point; When P_{Horizontal} is smaller than 0, the efficiency of the point is greater than that of right point. Finally, the method to regulate high efficiency region is revealed: if high efficiency region is desired to be adjusted to the target area, P_{vertical} and P_{Horfronfal} of the points of the target area should be optimized to approach 0.

Since the current will be smaller and the speed will be lower under the junction region of the constant torque region and the constant power region, the current angle does not change and this region still meets the equation of high efficiency regulation in the constant torque region.

FIG. 6 shows a diagram of the UDDS driving cycle, which represents a 31 minutes-18 km city travel with 23 stops. The average speed is 32 km/h and the maximum speed is 90 km/h.

FIG. 7 shows corresponding torque and speed distribution diagram based on UDDS driving cycle and motor parameter. As shown in FIG. 7, the motor operate mainly in low-torque medium-speed region under this driving cycle. If high efficiency region of the motor locates at this region, energy can be greatly saved. Otherwise, the energy will be wasted.

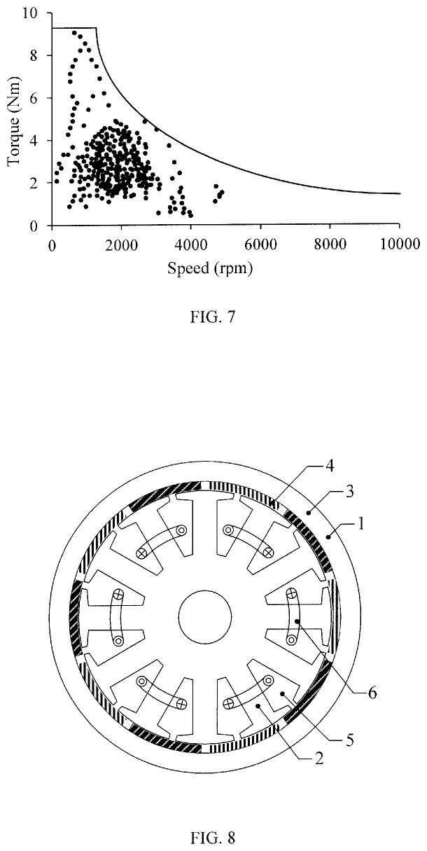

As shown in FIG. 8, the three-phase surface-mounted permanent magnet motor includes an outer rotor (1) and an inner stator (2). Meanwhile, the outer rotor (1) comprises rotor core (3) and 10 permanent magnetic poles (4). Besides, the inner stator (2) comprises 12 stator slots (5) and armature windings (6).

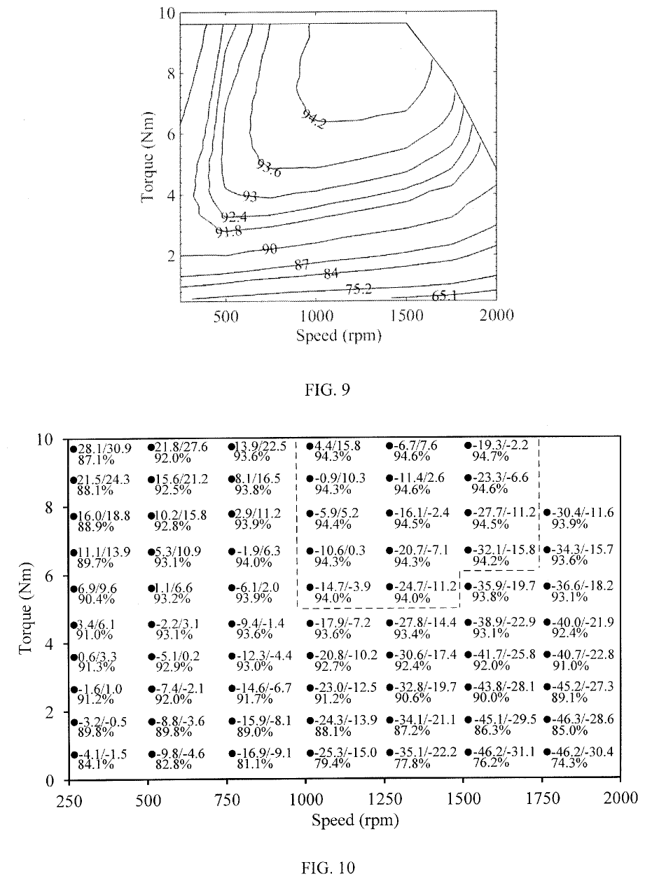

As shown in FIG. 9, the high efficiency region locates at a high torque region where the torque ranges from 6.14 Nm to 9.45 Nm and the speed ranges from 1000 rpm to 1500 rpm. The high efficiency region does not match with the driving cycle as shown in FIG. 7, which results in waste of energy.

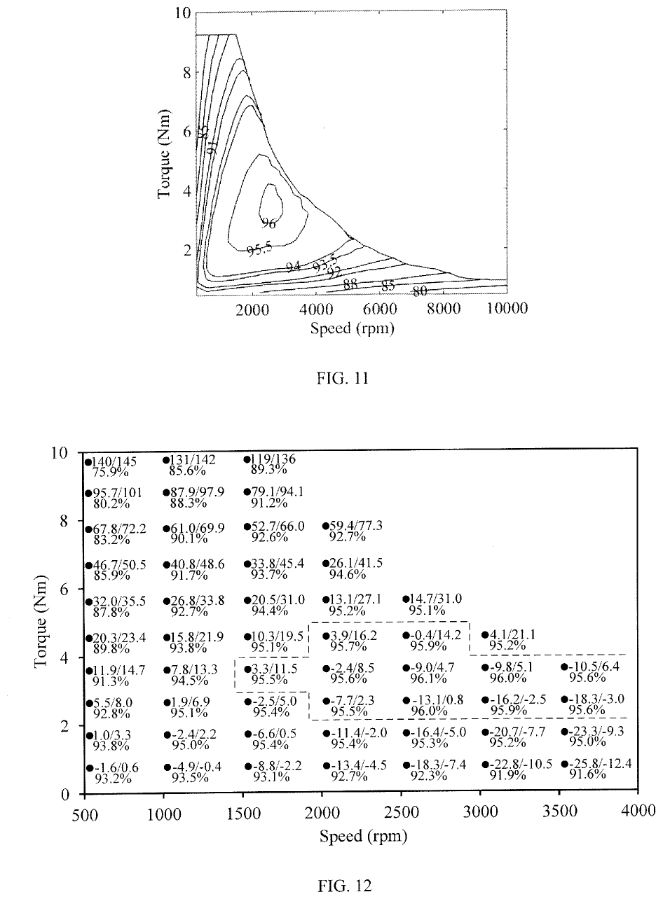

The data from the efficiency map in FIG. 9 are extracted and remarked in FIG. 10, aiming at analyze the reasons for the location of the high efficient area in FIG. 9. As shown in FIG. 10, every point includes three parts, and they represent P_{vertical}, P_{Horizontal} and efficiency of corresponding points. Taking the point in the second row and second column (15.6/21.2/92.5%) as an example, its efficiency (92.5%) is higher than the upper point (92.0%) and lower than the point below (92.8%) because P_{Vertical} (15.6) is greater than 0. Also, the efficiency of the point (92.5%) is higher than the left point (88.1%) and lower than the right point (93.8%) because P_{Horizontal} (21.2) is greater than 0. Moreover, only a few points in FIG. 10 dissatisfy the aforesaid description and this is because the P_{Vertical} or P_{Horizontal} of these points is very close to 0, which leads to errors.

According to the method to regulate high efficiency region, the reason why high efficiency region locates at the high torque region is that P_{Vertical} of points in this region are close to 0, while P_{Vertical} of points in low torque region is less than 0. Thus, the efficiency of low torque region is less than that of the upper high torque region. It can be seen that iron loss and permanent magnet eddy-current loss should be reduced or copper loss should be increased if high efficiency region is desired to move towards low torque region.

As shown in FIG. 11, the efficiency map is obtained by optimizing the pole-arc coefficient of the permanent magnet to 0.3. After the decrease of the pole-arc coefficient, the permanent magnetic field is weakened which leads to reduction of iron loss and permanent magnet eddy-current loss. In order to keep the peak torque constant, the current value increases, resulting in the increase of copper loss. It can be seen from FIG. 11 that the high efficiency region locates at a low torque area where the torque ranges from 2 Nm to 4.6 Nm and the speed ranges from 1350 rpm to 3500 rpm. It means that high efficiency region moves from high torque region to low torque region.

The data from the efficiency map in FIG. 11 are extracted and remarked in FIG. 12. It can be seen that every point in the constant torque region accords with the method to regulate high efficiency region.

In summary, the invention discloses a method to regulate high efficiency region of permanent magnet motor. By establishing the relationship between points in the constant torque region of efficiency map, the conditions that high efficiency region meets are derived.

Thus, high efficiency region can be regulated by optimizing loss. Based on given driving cycles of electric vehicles, high efficiency region is regulated by adopting regulating methods so as to improve efficiency and save energy.

Although the method herein described, and the forms of apparatus for carrying this method into effect, constitute preferred embodiments of this invention, it is to be understood that the invention is not limited to this precise method and forms of apparatus, and that changes may be made in either without departing form the scope of the invention, which is defined in the appended Claims.

1. A method to regulate a high efficiency region of a permanent magnet motor, which can be realized as follows:
in this method, nᵢ represents the speed of point ‘i’, Iᵢ represents the winding current amplitude of point ‘i’, P_{copp i} represents copper loss of point ‘i’, P_{iron i} represents iron loss of point ‘i’, P_{PM i} represents permanent magnet eddy-current loss of point ‘i’, P_{h i} represents hysteresis iron loss of point ‘i’, P_{c i} represents eddy-current iron loss of point ‘i’, P_{E i} represents additional iron loss of point ‘i’, P_{e i} represents power of point ‘i’; kᵢ represents a coefficient that is larger than 1 when i equals 2 or 5 and smaller than 1 when i equals 3 or 4;
Step 1: constant torque region of the target motor is firstly analyzed; in the constant torque region, point ‘1’ is set as the maximum efficiency point, and points ‘2’, ‘3’, ‘4’ and ‘5’ are selected as four directions around point ‘1’; then the relationship between the maximum efficiency point and other points is constructed;
Step 2: the relationships of speed and current between the maximum efficiency point ‘1’ and the top point ‘2’ in the constant torque region are n₂=n₁ and I₂=k₂I₁; then, the copper loss relationship between two points is obtained as P_{copp2}=k₂²P_{copp1}; furthermore, if the efficiency of point ‘1’ is greater than that of point ‘2’, the equation k₂P_{copp1}≥Pᵢᵣₒₙ₁+P_{PM1} will be deduced;
Step 3: the relationships of speed and current between the maximum efficiency point ‘1’ and the bottom point ‘3’ in the constant torque region are n₃=n₁ and I₃=k₃I₁; then, the copper loss relationship between two points is obtained as P_{copp3}=k₃²P_{copp1}; furthermore, if the efficiency of point ‘1’ is greater than that of point ‘3’, the equation k₃P_{copp1}<Pᵢᵣₒₙ₁+P_{PM1} will be deduced;
Step 4: the relationships of current, torque and speed between the maximum efficiency point ‘1’ and the right point ‘4’ in the constant torque region are I₄=I₁, T₄=T₁ and n₄=k₄n₁; then, the relationships of copper loss, hysteresis iron loss, eddy-current iron loss, additional iron loss and permanent magnet eddy-current loss are obtained as P_{copp4}=P_{copp1}, Pₕ₄=k₄Pₕ₁, P_{c4}=k₄²P_{c1}, P_{E4}=k₄^{1.5}P_{E1}, and P_{PM4}=k₄²P_{PM1}; furthermore, if the efficiency of point ‘1’ is greater than that of point ‘4’, the equation P_{copp1}<k₄(P_{c1}+P_{E1}+P_{PM1}) will be deduced;
Step 5: the relationships of current, torque and speed between the maximum efficiency point ‘ 1’ and the left point ‘5’ in the constant torque region are I₅=I₁, T₅=T₁ and n₅=k₅n₁; then, the relationships of copper loss, hysteresis iron loss, eddy-current iron loss, additional iron loss and permanent magnet eddy-current loss are obtained as P_{copp5}=P_{copp1}, Pₕ₅=k₅Pₕ₁, P_{c5}=k₅²P_{c1}, P_{E5}=k₅^{1.5}P_{E1}, and P_{PM5}=k₅²P_{PM1}; furthermore, if the efficiency of point ‘1’ is greater than that of point ‘4’, the equation P_{copp1}≥k₅(P_{c1}+P_{E1}+P_{PM1}) will be deduced;
Step 6: from Step 2 to Step 5, the maximum efficiency point needs to satisfy some equations, and then, the high efficiency point can be moved in horizontal and vertical direction according these equations;
Step 7: since the equations from Step 2 to Step 5 are only deduced in constant torque region, the effectiveness of these equations should be verified in other regions;
Step 8: the combination of copper loss, iron loss and permanent magnet eddy-current loss are analyzed to make point ‘1’ as the maximum efficiency point; then, three methods for adjusting the ratio of loss in high efficiency region by changing the parameters of winding, permanent magnet and silicon steel sheet can be used;
Step 9: the correctness of the proposed methods for adjusting high efficiency region is verified by specific driving cycles.

2. The method of claim 1 wherein, in Step 2:
firstly, the relationship of speed and current between point ‘1’ and point ‘2’ is established as:
$$\{ \begin{matrix}{n}_{2} = {n}_{1} \\ {I}_{2} = {k}_{2} {I}_{1}\end{matrix}$$
where n₂ is the speed of point ‘2’, n₁ is the speed of point ‘1’, I₂ is the winding current amplitude of point ‘2’, I₁ is the winding current amplitude of point ‘1’, and k₂ is a coefficient which is greater than 1;
secondly, the corresponding torque, electromagnetic power and copper loss are obtained from the relationship of speed and current between point ‘1’ and point ‘2’:
$$\{ \begin{matrix}{T}_{2} = {k}_{2} {T}_{1} \\ {P}_{e 2} = {k}_{2} {P}_{e 1} \\ {P}_{copp 2} = {k}_{2}^{2} {P}_{copp 1}\end{matrix}$$
where T₂ is the torque of point ‘2’, T₁ is the torque of point ‘1’, Pₑ₂ is the power of point ‘2’, Pₑ₁ is the power of point ‘1’, P_{copp2} is the copper loss of point ‘2’, and P_{copp1} is the copper loss of point ‘1’;
thirdly, ignoring motor mechanical loss and wind friction loss, the efficiency expressions of point ‘1’ and point ‘2’ are as follows:
$$\{ \begin{matrix}{η}_{1} = \frac{{P}_{e 1}}{{P}_{e 1} + {P}_{copp 1} + {P}_{iron 1} + {P}_{PM 1}} \\ {η}_{2} = \frac{{P}_{e 2}}{{P}_{e 2} + {P}_{copp 2} + {P}_{iron 2} + {P}_{PM 2}}\end{matrix}$$
where η₂ is the efficiency of point ‘2’, η₁ is the efficiency of point ‘1’, Pᵢᵣₒₙ₂ is the iron loss of point ‘2’, Pᵢᵣₒₙ₁ is the iron loss of point ‘1’, P_{PM2} is the permanent magnet eddy-current loss of point ‘2’, and P_{PM1} is the permanent magnet eddy-current loss of point ‘1’;
finally, if the efficiency of point ‘1’ is greater than that of point ‘2’, the following equation will be obtained:
$$\{ \begin{matrix}y = {k}_{2} ( {k}_{2} - 1 ) {P}_{copp 1} > ( {k}_{2} {P}_{iron 1} - {P}_{iron 2} ) + ( {k}_{2} {P}_{P M 1} - {P}_{P M 2} ) = x \\ z = ( {k}_{2} - 1 ) {P}_{iron 1} + ( {k}_{2} - 1 ) {P}_{P M 1} > x\end{matrix}$$
when point ‘1’ and point ‘2’ are very close to each other, Pᵢᵣₒₙ₂ and P_{PM2} are slightly greater than Pᵢᵣₒₙ₁ and P_{PM1}, respectively, thus, z is slightly greater than x, while x is smaller than y; after simplification, the following equation can be obtained as indicated in Step 2 of claim 1:
k₂P_{copp1}≥Pᵢᵣₒₙ₁+P_{PM1}.

3. The method of claim 1 wherein, in Step 3:
firstly, the relationship of speed and current between point ‘1’ and point ‘3’ is established as follows:
$$\{ \begin{matrix}{n}_{3} = {n}_{1} \\ {I}_{3} = {k}_{3} {I}_{1}\end{matrix}$$
where η₃ is the speed of point ‘3’, I₃ is the winding current amplitude of point ‘3’, and k₃ is a coefficient which is smaller than 1;
secondly, the corresponding torque, electromagnetic power and copper loss are obtained from the relationship of speed and current between point ‘1’ and point ‘3’:
$$\{ \begin{matrix}{T}_{3} = {k}_{3} {T}_{1} \\ {P}_{e3} = {k}_{3} {P}_{e 1} \\ {P}_{copp 3} = {k}_{3}^{2} {P}_{copp 1}\end{matrix}$$
where T₃ is the torque of point ‘3’, Pₑ₃ is the power of point ‘3’, and P_{copp3} is the copper loss of point ‘3’;
thirdly, ignoring motor mechanical loss and wind friction loss, the efficiency expressions of point ‘1’ and point ‘2’ are as follows:
$$\{ \begin{matrix}{η}_{1} = \frac{{P}_{e 1}}{{P}_{e 1} + {P}_{copp 1} + {P}_{iron 1} + {P}_{P M 1}} \\ {η}_{3} = \frac{{P}_{e 3}}{{P}_{e 3} + {P}_{copp 3} + {P}_{iron 3} + {P}_{P M 3}}\end{matrix}$$
where η₃ is the efficiency of point ‘3’, Pᵢᵣₒₙ₃ is the iron loss of point ‘3’, and P_{PM3} is the permanent magnet eddy-current loss of point ‘3’;
finally, if the efficiency of point ‘1’ is greater than that of point ‘3’, the following equation will be obtained:
$$\{ \begin{matrix}y = {k}_{3} ( {k}_{3} - 1 ) {P}_{copp 1} > ( {k}_{3} {P}_{iron 1} - {P}_{iron 3} ) + ( {k}_{3} {P}_{P M 1} - {P}_{PM 3} ) = x \\ z = ( {k}_{3} - 1 ) {P}_{iron 1} + ( {k}_{3} - 1 ) {P}_{P M 1} < x\end{matrix}$$
when point ‘1’ and point ‘3’ are very close to each other, Pᵢᵣₒₙ₃ and P_{PM3} are slightly smaller than Pᵢᵣₒₙ₁ and P_{PM1}, respectively; thus, z is slightly smaller than x, while x is smaller than y. After simplification, the following equation can be obtained as indicated in Step 3 of claim 1:
k₃P_{copp1}<Pᵢᵣₒₙ₁+P_{PM1}.

4. The method of claim 1 wherein, in Step 4:
firstly, the relationship of current, torque and speed between point ‘1’ and point ‘4’ is established as follows:
$$\{ \begin{matrix}{I}_{4} = {I}_{1} \\ {T}_{4} = {T}_{1} \\ {n}_{4} = {k}_{4} {n}_{1}\end{matrix}$$
where I₄ is the winding current amplitude of point ‘4’, T₄ is the torque of point ‘4’, n₄ is the speed of point ‘4’, and k₄ is a coefficient which is greater than 1;
secondly, the corresponding electromagnetic power, copper loss, hysteresis iron loss, eddy-current iron loss, additional iron loss and permanent magnet eddy-current loss are obtained from the relationship of current, torque and speed between point ‘1’ and point ‘4’:
$$\{ \begin{matrix}{P}_{e 4} = {k}_{4} {P}_{e 1} \\ {P}_{c o p p 4} = {P}_{c o p p 1} \\ {P}_{h 4} = {k}_{4} {P}_{h 1} \\ {P}_{c 4} = {k}_{4}^{2} {P}_{c 1} \\ {P}_{E 4} = {k}_{4}^{1.5} {P}_{E 1} \\ {P}_{P M 4} = {k}_{4}^{2} {P}_{PM 1}\end{matrix}$$
where Pₑ₄ is the power of point ‘4’, P_{copp4} is the copper loss of point ‘4’, Pₕ₄ is the hysteresis iron loss of point ‘4’, P_{c4} is the eddy-current iron loss of point ‘4’, P_{E4} is the additional iron loss of point ‘4’, P_{PM4} is the permanent magnet eddy-current loss of point ‘4’, Pₕ₁ is the hysteresis iron loss of point ‘1’, P_{c1} is the eddy-current iron loss of point ‘1’, and P_{E1} is the additional iron loss of point ‘1’;
thirdly, ignoring motor mechanical loss and wind friction loss, the efficiency expressions of point ‘1’ and point ‘4’ are as follows:
$$\{ \begin{matrix}{η}_{1} = \frac{{P}_{e 1}}{{P}_{e 1} + {P}_{copp 1} + {P}_{iron 1} + {P}_{PM 1}} \\ {η}_{4} = \frac{{P}_{e 4}}{{P}_{e 4} + {P}_{copp 4} + {P}_{iron 4} + {P}_{PM 4}}\end{matrix}$$
where η₄ is the efficiency of point ‘4’;
finally, if the efficiency of point ‘1’ is greater than that of point ‘4’, the following equation will be obtained:
$$\{ \begin{matrix}v = ( {k}_{4} - 1 ) {P}_{copp 1} < ( {k}_{4}^{2} - {k}_{4} ) {P}_{c 1} + ( {k}_{4}^{1.5} - {k}_{4} ) {P}_{E 1} + ( {k}_{4}^{2} - {k}_{4} ) {P}_{P M 1} = u \\ w = ( {k}_{4}^{2} - {k}_{4} ) {P}_{c 1} + ( {k}_{4}^{2} - {k}_{4} ) {P}_{E 1} + ( {k}_{4}^{2} - {k}_{4} ) {P}_{PM 1} > u\end{matrix}$$
when point ‘1’ and point ‘4’ are very close to each other, the coefficient (k₄²−k₄) is slightly greater than the coefficient (k₄^{1.5}−k₄); thus, w is slightly greater than u, while u is greater than v. After simplification, the following equation can be obtained as indicated in Step 4 of claim 1:
P_{copp1}<k₄(P_{c1}+P_{E1}+P_{PM1})

5. The method of claim 1 wherein, in Step 5:
firstly, the relationship of current, torque and speed between point ‘1’ and point ‘5’ is established as follows:
$$\{ \begin{matrix}{I}_{5} = {I}_{1} \\ {T}_{5} = {T}_{1} \\ {n}_{5} = {k}_{5} {n}_{1}\end{matrix}$$
where I₅ is the winding current amplitude of point ‘5’, T₅ is the torque of point ‘5’, n₅ is the speed of point ‘5’, and k₅ is a coefficient which is smaller than 1;
secondly, the corresponding electromagnetic power, copper loss, hysteresis iron loss, eddy-current iron loss, additional iron loss and permanent magnet eddy-current loss are obtained from the relationship of current, torque and speed between point ‘1’ and point ‘5’:
$$\{ \begin{matrix}{P}_{e 5} = {k}_{5} {P}_{e 1} \\ {P}_{copp 5} = {P}_{copp 1} \\ {P}_{h5} = {k}_{5} {P}_{h 1} \\ {P}_{c5} = {k}_{5}^{2} {P}_{c 1} \\ {P}_{E5} = {k}_{5}^{1.5} {P}_{E 1} \\ {P}_{PM 5} = {k}_{5}^{2} {P}_{PM 1}\end{matrix}$$
where Pₑ₅ is the power of point ‘5’, P_{copp5} is the copper loss of point ‘5’, Pₕ₅ is the hysteresis iron loss of point ‘5’, Pₑ₅ is the eddy-current iron loss of point ‘5’, P_{E5} is the additional iron loss of point ‘5’, and P_{PM5} is the permanent magnet eddy-current loss of point ‘5’;
thirdly, ignoring motor mechanical loss and wind friction loss, the efficiency expressions of point ‘1’ and point ‘5’ are as follows:
$$\{ \begin{matrix}{η}_{1} = \frac{{P}_{e 1}}{{P}_{e 1} + {P}_{copp 1} + {P}_{iron 1} + {P}_{PM 1}} \\ {η}_{5} = \frac{{P}_{e 5}}{{P}_{e 5} + {P}_{copp 5} + {P}_{iron 5} + {P}_{PM 5}}\end{matrix}$$
where η₅ is the efficiency of point ‘5’;
finally, if the efficiency of point ‘1’ is greater than that of point ‘5’, the following equation will be obtained:
$$\{ \begin{matrix}v = ( {k}_{5} - 1 ) {P}_{copp 1} < ( {k}_{5}^{2} - {k}_{5} ) {P}_{c 1} + ( {k}_{5}^{1.5} - {k}_{5} ) {P}_{E 1} + ( {k}_{5}^{2} - {k}_{5} ) {P}_{P M 1} = u \\ w = ( {k}_{5}^{2} - {k}_{5} ) {P}_{c 1} + ( {k}_{5}^{2} - {k}_{5} ) {P}_{E 1} + ( {k}_{5}^{2} - {k}_{5} ) {P}_{PM 1} < u\end{matrix}$$
when point ‘1’ and point ‘5’ are very close to each other, the coefficient (k₅²−k₅)P_{E1} is slightly smaller than the coefficient (k₅^{1.5}−k₅)P_{E1}; thus, w is slightly smaller than u, while u is greater than v; after simplification, the following relationship can be obtained as indicated in Step 5 of claim 1:
P_{copp1}≥k₅(P_{c1}+P_{E1}P_{PM1}).

6. The method, according to claim 1, wherein the high efficiency point can be moved in horizontal and vertical direction, when the loss in the motor satisfies the following equation:
$$\{ \begin{matrix}{P}_{Vertical} = {P}_{copp} - ( {P}_{iron} + {P}_{P M} ) \approx 0 \\ {P}_{Horizontal} = {P}_{copp} - ( {P}_{c} + {P}_{E} + {P}_{P M} ) \approx 0\end{matrix}$$
where P_{copp} represents copper loss, Pᵢᵣₒₙ represents iron loss, P_{PM} represents permanent magnet eddy-current loss, P_{c} represents eddy-current iron loss, and P_{E} represents additional iron loss; when P_{vertical} is greater than 0, the efficiency of the point is greater than that of top point; when P_{vertical} is smaller than 0, the efficiency of the point is greater than that of bottom point; when P_{Horizontal} is greater than 0, the efficiency of the point is greater than that of left point; when P_{Horizontal} is smaller than 0, the efficiency of the point is greater than that of right point; and if high efficiency region is desired to be adjusted to the target area, P_{vertical} and P_{Horizontal} of the points of the target area should be optimized to approach 0.

7. The method, according to claim 1, wherein, because the current will be smaller and the speed will be lower under the junction region of the constant torque region and the constant power region, the current angle does not change; and then, this region still meets the equation of high efficiency regulation in the constant torque region.

8. The method, according to claim 1, wherein the copper loss, iron loss and permanent magnet eddy-current loss can be represented by expressions as:
$$\{ \begin{matrix}{P}_{copp} = \frac{m {I}^{2} R}{2} \\ {P}_{iron} = {P}_{h} + {P}_{c} + {P}_{E} \\ {P}_{P M} = \frac{{K}^{2} {f}^{2} {L}_{a} {B}_{m}^{2} {L}_{m}^{2} V}{12 ρ ( {L}_{a} + {L}_{m} )}\end{matrix}$$
where m represents phase number of the motor, I represents winding current amplitude, R represents winding resistance per phase, Pₕ represents hysteresis iron loss, K represents a electromotive force constant, f represents frequency, Lₐ represents axial length of the motor, Bₘ represents maximum flux density. Lₘ represents width of the permanent magnet, V represents volume, and ρ represents resistivity; copper loss can be adjusted by changing the winding current amplitude or winding resistance, and winding resistance is mainly determined by the winding length after the determination of the line diameter; iron loss can be adjusted by changing the magnitude of the armature magnetic field or the permanent magnetic field; and permanent magnet eddy current loss can be adjusted by rotor opening, radial or axial segmentation, changing the pole-arc coefficient of permanent magnet, changing the opening size of stator slot, and changing the permanent magnet material.

9. The method, according to claim 1, wherein three methods for adjusting the loss ratio of high efficiency region are by changing the parameters of winding, permanent magnet and silicon steel sheet; to make high efficiency region move towards the top or left, the following measures can be adopted: reducing the current amplitude, increasing the number of winding turns, increasing the pole-arc coefficient of the permanent magnet, and increasing the opening size of the stator slot; conversely, to make high efficiency region move towards the bottom or right, the following measures can be adopted: increasing the current amplitude, reducing the number of winding turns, reducing the pole-arc coefficient of the permanent magnet, reducing the opening size of the stator slot, and radial or axial segmentation of permanent magnet.

10. (canceled)
